(19) United States
(12) Patent Application Publication
(10) Pub. No.: US 2003/0197760 A1
(43) Pub. Date: Oct. 23, 2003

(54) Ink jet recording head

(75) Inventors: Ken Tsuchii, Kanagawa (JP); Mineo Kaneko, Tokyo (JP); Keiichiro Tsukuda, Kanagawa (JP); Masaki Oikawa, Tokyo (JP); Kenji Yabe, Kanagawa (JP); Keiji Tomizawa, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/419,839

(22) Filed: Apr. 22, 2003

(30) Foreign Application Priority Data
Apr. 23, 2002 (JP) 2002-121209

(51) Int. Cl. B41J 2/05

(52) U.S. Cl. 347/56

(57) ABSTRACT

In an ink jet recording head according to the present invention in which a small ink droplet and a large ink droplet can be discharged, a common liquid chamber is connected to discharge ports via ink flow paths and pressure chambers, and ink droplets are discharged from the discharge ports by utilizing thermal energy of heaters. Widths of the ink flow paths are narrower than widths of the pressure chambers so that the ink flow paths act as restriction portions. When it is assumed that a sectional area of the small liquid droplet ink flow path is S_{S}, a sectional area of the small liquid droplet pressure chamber is S_{RS}, a sectional area of the large liquid droplet ink flow path is S_{L} and a sectional area of the large liquid droplet pressure chamber is S_{RL}, a relationship S_{S}/S_{RS}<S_{L}/S_{RL} is established. According to the present invention, with this arrangement, even in the nozzle for discharging the small ink droplet, loss is reduced and energy efficiency can be enhanced.

### BACKGROUND OF THE INVENTION

1. Field of the Invention

The present invention relates to an ink jet recording head for performing recording by discharging an ink droplet from a discharge port and by adhering the ink droplet onto a recording medium.

2. Related Background Art

As one of ink discharging methods in ink jet recording apparatuses, which have now used widely, there is a method utilizing an electro-thermal converting element (heater). The principle is that heat is generated by applying an electrical signal to the electro-thermal converting element disposed in a pressure chamber to which ink is supplied thereby to heat the ink near the electro-thermal converting element instantaneously to boil the ink, with the result that the ink is discharged from a discharge port externally by great bubble pressure abruptly generated due to phase change. An ink jet recording head of this type has advantages that a structure is simple and that integration of ink flow paths is facilitated.

In such an ink jet recording head, since there is a case where recording is performed by forming an ink droplet finer than the normal ink droplet in order to realize highly fine recording. To this end, there has been proposed an arrangement in which the discharging of the larger ink droplet and the discharging of the smaller ink droplet are used properly. In general, it can be considered that the discharge port and the electro-thermal converting element must be miniaturized in order to discharge the smaller ink droplet.

Concretely, in order to reduce a size of the discharged liquid droplet, a discharge port area is made smaller substantially in inverse proportion to a discharge amount. For example, when an ink droplet of 5 pl is preferably discharged from a discharge port having a diameter of 16 to 16.5 μm (area is 201 to 214 μm²), it is considered to be preferable that a discharge port for discharging a smaller ink droplet (for example, 4 pl) has a diameter of about 15.5 μm (area is 189 μm²) and a discharge port for discharging a more smaller ink droplet (for example, 2 pl) has a diameter of about 10.5 μm (area is 87 μm²).

According to a normal designing method, when the discharge port and the electro-thermal converting element are miniaturized in order to discharge the small ink droplet, the pressure chamber within which the electro-thermal converting element is installed is also miniaturized accordingly. An ink flow path for connecting the pressure chamber to a common liquid chamber is designed to have a width same as a width of the pressure chamber. That is to say, in correspondence to the miniaturization of the ink droplet, the discharge port, electro-thermal converting element and pressure chamber are all miniaturized at the same rate, and the pressure chamber and the ink flow path are formed to have the same width.

However, in such a designing method, it was found that there is a case where the minute ink droplet may not be discharged successfully. That is to say, even if a small liquid discharging nozzle is constructed by reducing dimensions of the discharge port, electro-thermal converting element and pressure chamber which can discharge the normal ink droplet (large ink droplet) successfully in proportion to reduction of an ink amount of the ink droplet to be discharged, in many cases, the good ink droplet discharging cannot be achieved. It is guessed that one of factors causing the poor discharging is the fact that flow resistance is increased by the miniaturization of the discharge port.

Explaining this more concretely, viscosity resistance of the discharge port is increased in inverse proportion to fourth power of the area of the discharge port. That is to say, when the discharge port is miniaturized in correspondence to the miniaturization of the ink droplet, since the viscosity resistance is increased, in order to maintain the proper discharging condition if the viscosity resistance is increased, a bubbling power generated by the electro-thermal converting element must be increased. In the above-mentioned conventional designing method, although it was considered that the bubbling power of the electro-thermal converting element can merely be decreased in accordance with the miniaturization of the discharged ink droplet, actually, it is considered that, in addition to this, a bubbling power required for overcoming the increased viscosity resistance should be considered. Accordingly, the minimum bubbling power required for discharging the ink droplet from the discharge port successfully cannot eventually be reduced much in comparison with the case where the large ink droplet is discharged because the fact that the power can be reduced in accordance with the miniaturization of the ink droplet to be discharged is cancelled by the fact that the power must be increased to cope with the increase in viscosity resistance, with the result that the size of the electro-thermal converting element cannot be reduced much.

Further, due to limitation of the design of the ink jet recording head, in a certain case, a distance between the electro-thermal converting element and the discharge port cannot be shortened in accordance with the miniaturization of the ink droplet to be discharged and the discharge port. That is to say, there is a case where the distance between the electro-thermal converting element and the discharge port becomes constant by forming the discharge port for discharging the large ink droplet and the discharge port for discharging the small ink droplet in a single substrate and installing the corresponding electro-thermal converting elements in parallel on the single substrate in order to simplify a construction and a manufacturing process. In this case, even when the diameter of the discharge port is decreased in accordance with the miniaturization of the ink droplet to be discharged, the distance to the discharge port cannot be shortened, thereby causing bad balance. Since the distance to the discharge port is long relatively, energy required for discharging the ink out of the discharge port becomes relatively great.

Also from this reason, the minimum energy required for discharging the ink droplet cannot be reduced much in comparison with the rate of reduction of the amount of the ink droplet and the rate of the miniaturization of the discharge port, and the size of the electro-thermal converting element cannot be reduced much in comparison with the electro-thermal converting element for discharging the large ink droplet.

For example, in the above-mentioned example, if the electro-thermal converting element used for discharging the ink droplet of 5 pl has a square shape of 26 μm×26 μm (or two elements having a dimension of 12.5 μm×28 μm), the electro-thermal converting element for discharging the ink droplet of 4 pl is required to have a square shape of about 24 μm×24 μm, and, the electro-thermal converting element required for discharging the ink droplet of 2 pl becomes a square shape of about 22 μm×22 μm (or two elements having a dimension of about 11.5 μm×27 μm). As such, while the discharge port can be miniaturized in accordance with the reduction of the dimension of the ink droplet, in comparison with this, the electro-thermal converting element cannot be miniaturized so much.

Further, the pressure chamber for discharging the small ink droplet cannot be miniaturized so much since it must contain the electro-thermal converting element. When margin of 2 μm is provided around an outer periphery of the electro-thermal converting element in consideration of alignment error of a flow path forming member, for example, the pressure chamber required for discharging the ink droplet of 5 pl must have a square shape of (26+4) μm×(26+4) μm 30 μm×30 μm (bottom area is 900 μm²) or a square shape of (12.5×2+3+4) μm×(28+4) μm=32 μm×32 μm (bottom area is 1,024 μm²). To the contrary, the pressure chamber required for discharging the ink droplet of 4 pl has a square shape of (24+4) μm×(24+4) μm=28 μm×28 μm (bottom area is 784 μm²), and the pressure chamber required for discharging the ink droplet of 2 pl has a square shape of (22+4) μm×(22+4) μm=26 μm×26 μm (bottom area is 676 μm²) or a rectangular shape of (11.5×2+3+4) μm×(27+4) μm=30 μm×31 μm (bottom area is 930 μm²).

As such, when the minute ink droplet is discharged, the electro-thermal converting element and the pressure chamber cannot be miniaturized so much in comparison with the rate of the miniaturization of the discharge port.

As mentioned above, since the ink flow path having the same width of that of the pressure chamber is normally provided, when the pressure chamber is not miniaturized so much, the width of the ink flow path is not reduced so much. As a result, among the bubbling power of the electro-thermal converting eminent, a power component directing toward the ink flow path side rather than the discharge port side and not contributing to the discharging of the ink droplet is increased to cause great loss, thereby worsening energy efficiency.

### SUMMARY OF THE INVENTION

Accordingly, an object of the present invention is to provide an ink jet recording head in which loss can be reduced and energy efficiency can be enhanced also in a nozzle for discharging a small ink droplet, on the basis of a unique designing method, which is unknown in the prior art.

The present invention provides an ink jet recording head in which pressure chambers are connected to a plurality of respective ink flow paths branched from a common liquid chamber, discharge ports are communicated with the respective pressure chambers, ink supplied from the common liquid chamber to each pressure chamber can be discharged from the corresponding discharge port by pressure generated in the pressure chamber by heat from a corresponding electro-thermal converting element and wherein the plurality of pressure chambers include a small liquid droplet pressure chamber for discharging a small liquid droplet and a large liquid droplet pressure chamber for discharging a large liquid droplet, and, regarding the ink flow path for the small liquid droplet connected to the small liquid droplet pressure chamber, the small liquid droplet pressure chamber, the ink flow path for the large liquid droplet connected to the large liquid droplet pressure chamber and the large liquid droplet pressure chamber, when a section substantially perpendicular to ink flows directing from the respective ink flow paths to the respective pressure chambers are looked at, a relationship between a sectional area S_{S} of the small liquid droplet ink flow path, a sectional area S_{RS} of the small liquid droplet pressure chamber, a sectional area S_{L} of the large liquid droplet ink flow path and a sectional area S_{RL} of the large liquid droplet pressure chamber satisfies S_{S}/S_{RS}<S_{L}/S_{RL}.

Further, it is preferable that a relationship between the sectional area S_{RS} of the small liquid droplet pressure chamber and the sectional area S_{RL} of the large liquid droplet pressure chamber and an ink amount I_{S} of the small liquid droplet discharged from the small liquid droplet pressure chamber and an ink amount I_{L} of the large liquid droplet discharged from the large liquid droplet pressure chamber satisfies S_{RS}/S_{RL}>I_{S}/I_{L}.

Further, it is preferable that a relationship between a volume V_{RS} of the small liquid droplet pressure chamber and a volume V_{RL} of the large liquid droplet pressure chamber and the ink amount I_{S} of the small liquid droplet discharged from the small liquid droplet pressure chamber and the ink amount I_{L} of the large liquid droplet discharged from the large liquid droplet pressure chamber satisfies V_{RS}/V_{RL}>I_{S}/I_{L}.

Further, S_{L}=S_{RL} and S_{S}<S_{RS} may be satisfied.

Further, it is preferable that the following relationships are satisfied:

S_{Lb}<S_{Sb}<1.93 S_{Lb}

S_{Lb}=R_{Lf}/(R_{Lf}+R_{Lb})×S_{Le}

S_{Sb}=R_{Sf}/(R_{Sf}+R_{Sb})×S_{Se}

S_{Lb}: flow resistance of large liquid droplet side;

S_{Sb}: flow resistance of small liquid droplet side;

R_{Lf}: flow resistance from electro-thermal converting element of large liquid droplet pressure chamber to discharge port;

R_{Lb}: flow resistance from electro-thermal converting element of large liquid droplet ink flow path to common liquid chamber;

S_{Le}: effective bubbling area of the large liquid droplet electro-thermal converting element;

R_{Sf}: flow resistance from electro-thermal converting element of small liquid droplet pressure chamber to discharge port;

R_{Sb}: flow resistance from electro-thermal converting element of small liquid droplet ink flow path to common liquid chamber; and

S_{Se}: effective bubbling area of small liquid droplet electro-thermal converting element.

Further, the following relationships or equations may be satisfied:

$$Rf = η {\int }_{0}^{H} D ( x ) ⅆ x / {S ( x )}^{2}$$

D(x)=12.0×(0.33+1.02×(a(x)/b(x)+b(x)/a(x)))

R_{f}: flow resistance from electro-thermal converting element to discharge port;

H: distance from electro-thermal converting element to discharge port;

x: distance from electro-thermal converting element;

S(x): sectional area of ink flow path at position of distance x;

D(x): section coefficient of ink flow path at position of distance x;

a(x): height of ink flow path at position of distance x;

b(x): width of ink flow path at position of distance x; and

η: ink viscosity, and,

$$Rb = η {\int }_{0}^{L} D ( y ) ⅆ y / {S ( y )}^{2}$$

D(y)=12.0×(0.33+1.02×(c(y)/d(y)+d(y)/c(y)))

R_{b}: flow resistance from electro-thermal converting element to common liquid chamber;

L: distance from center of electro-thermal converting element to common liquid chamber;

y: distance from the common liquid chamber;

S(y): sectional area of ink flow path at position of distance y;

D(y): section coefficient of ink flow path at position of distance y;

c(y): height of ink flow path at position of distance y; and

d(y): width of ink flow path at position of distance

Further, the following relationships may be satisfied:

$$Rf = η {\sum }_{n = 1}^{k} D ( {x}_{n} ) ( {x}_{n} - {x}_{n - 1} ) / {S ( {x}_{n} )}^{2}$$

D(xₙ)=12.0×(0.33+1.02×(a(xₙ)/b(xₙ)+b(xₙ)/a(xₙ))

R_{f}: flow resistance from electro-thermal converting element to discharge port;

k: division number of distance from electro-thermal converting element to discharge port;

xₙ: distance from electro-thermal converting element to n-th division position when distance from electro-thermal converting element to discharge port is divided into k sections;

S(xₙ): sectional area of ink flow path at position of xₙ;

D(xₙ): section coefficient of ink flow path at position of xₙ;

a(xₙ) : height of ink flow path at position of xₙ;

b(xₙ): width of ink flow path at position of xₙ; and

η: ink viscosity, and,

$$Rb = η {\sum }_{n = 1}^{l} D ( {y}_{n} ) ( {y}_{n} - {y}_{n - 1} ) / {S ( {y}_{n} )}^{2}$$

D(yₙ)=12.0×(0.33+1.02×(c(yₙ)/d(yₙ)+d(yₙ)/c(yₙ)))

R_{b}: flow resistance from electro-thermal converting element to common liquid chamber;

l: division number of distance from center of electro-thermal converting element to common liquid chamber;

yₙ: distance from common liquid chamber to n-th division position when distance from center of electro-thermal converting element to common liquid chamber is divided into l sections;

S(yₙ): sectional area of ink flow path at position of yₙ; _{D(y}ₙ) : section coefficient of ink flow path at position of yₙ;

c(yₙ): height of ink flow path at position of yₙ; and

d(yₙ): width of ink flow path at position of yₙ.

Further, the following relationships may be satisfied:

$$Rf = ρ {\int }_{0}^{H} ⅆ x / S ( x )$$

R_{f}: flow resistance from electro-thermal converting element to discharge port;

H: distance from electro-thermal converting element to discharge port;

x: distance from electro-thermal converting element;

S(x): sectional area of ink flow path at position of distance x; and

ρ: ink density, and,

$$Rb = ρ {\int }_{0}^{L} ⅆ y / S ( y )$$

R_{b}: flow resistance from electro-thermal converting element to common liquid chamber;

L: distance from center of electro-thermal converting element to common liquid chamber;

y: distance from the common liquid chamber; and

S(y): sectional area of ink flow path at position of distance y.

Further, the following relationships may be satisfied:

$$Rf = ρ {\sum }_{n = 1}^{k} ( {x}_{n} - {x}_{n - 1} ) / S ( {x}_{n} )$$

R_{f}: flow resistance from electro-thermal converting element to discharge port;

k: division number of distance from electro-thermal converting element to discharge port;

xₙ: distance from electro-thermal converting element to n-th division position when distance from electro-thermal converting element to discharge port is divided into k sections;

S(xₙ): sectional area of ink flow path at position of xₙ; and

η: ink viscosity, and,

$$Rb = ρ {\sum }_{n = 1}^{l} ( {y}_{n} - {y}_{n - 1} ) / S ( {y}_{n} )$$

R_{b}: flow resistance from electro-thermal converting element to common liquid chamber;

l: division number of distance from center of electro-thermal converting element to common liquid chamber;

yₙ: distance from common liquid chamber to n-th division position when distance from center of electro-thermal converting element to common liquid chamber is divided into l sections; and

S(yₙ): sectional area of ink flow path at position of yₙ.

### BRIEF DESCRIPTION OF THE DRAWINGS

FIG. 1A is a schematic plan view showing a fundamental construction of an ink jet recording head according to a first reference example, and FIG. 1B is a sectional view thereof;

FIG. 2A is an enlarged plan view showing main part of the ink jet recording head according to the first reference example shown in FIG. 1A with partially omitted, and FIG. 2B is a sectional view taken along the line 2B-2B;

FIG. 3A is an enlarged plan view showing main part of an ink jet recording head according to a second reference example with partially omitted, and FIG. 3B is a sectional view taken along the line 3B-3B;

FIG. 4A is an enlarged plan view showing main part of an ink jet recording head according to a first embodiment of the present invention with partially omitted, and FIG. 4B is a sectional view taken along the line 4B-4B;

FIG. 5A is an enlarged plan view showing main part of an ink jet recording head according to a second embodiment of the present invention with partially omitted, and FIG. 5B is a sectional view taken along the line 5B-5B;

FIG. 6A is an enlarged plan view showing main part of an ink jet recording head according to a third reference example with partially omitted, and FIG. 6B is a sectional view taken along the line 6B-6B;

FIG. 7A is an enlarged plan view showing main part of an ink jet recording head according to a fourth reference example with partially omitted, and FIG. 7B is a sectional view taken along the line 7B-7B;

FIG. 8A is an enlarged plan view showing main part of an ink jet recording head according to a third embodiment of the present invention with partially omitted, and FIG. 8B is a sectional view taken along the line 8B-8B;

FIG. 9A is an enlarged plan view showing main part of an ink jet recording head according to a fourth embodiment of the present invention with partially omitted, and FIG. 9B is a sectional view taken along the line 9B-9B; and

FIG. 10A is an enlarged plan view showing main part of an ink jet recording head according to a fifth embodiment of the present invention with partially omitted, and FIG. 10B is a sectional view taken along the line 10B-10B.

### DESCRIPTION OF THE PREFERRED EMBODIMENTS

Now, embodiments of the present invention and reference examples will be explained with reference to the accompanying drawings.

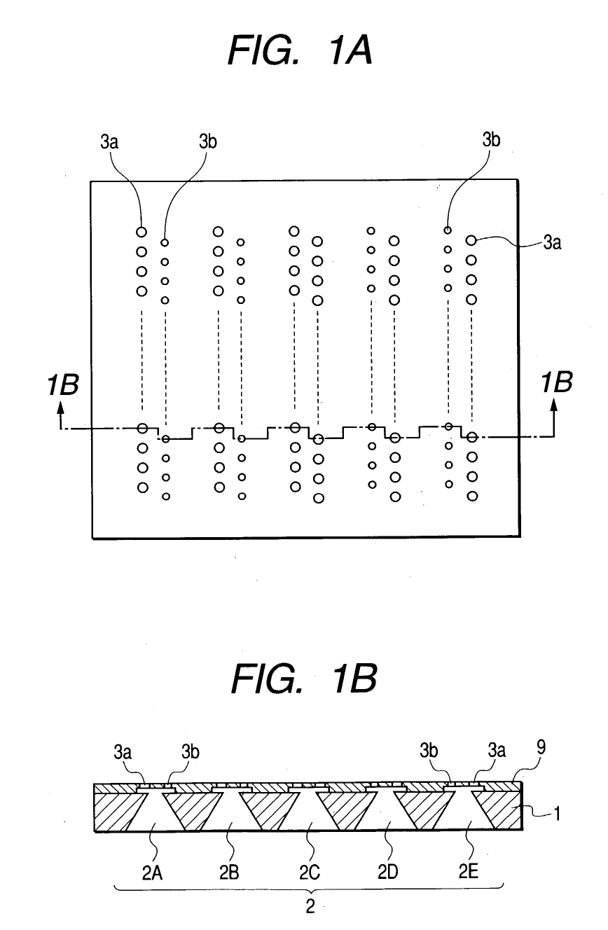

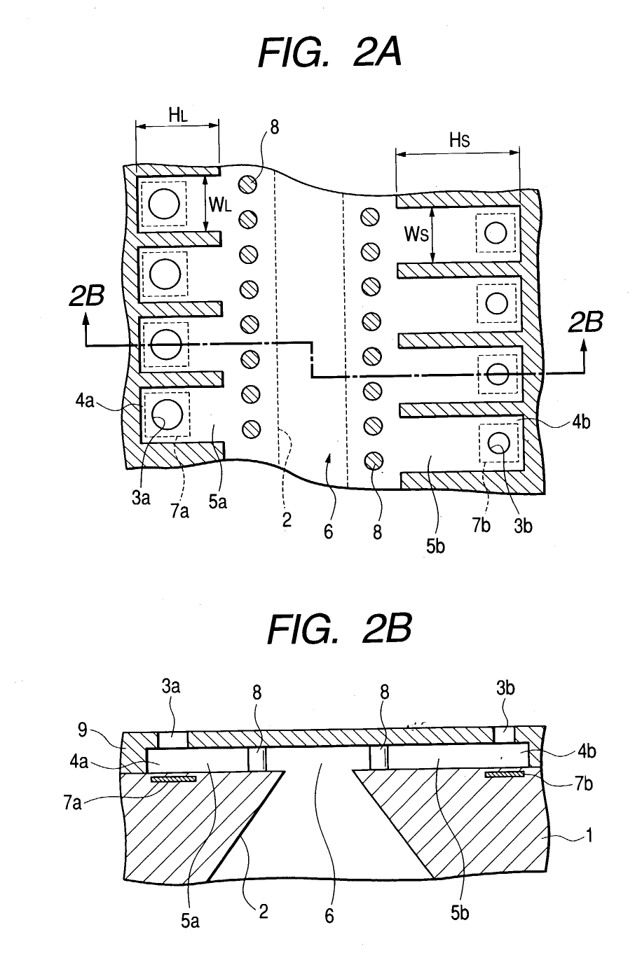

An ink jet recording head according to a first reference example is shown in FIGS. 1A and 1B and FIGS. 2A and 2B. As shown in FIGS. 1A and 1B, in a fundamental construction of the ink jet recording head, five ink supply ports 5 are formed in a single substrate 1, and cyan ink is supplied to the ink supply ports 2A and 2E, magenta ink is supplied to the ink supply ports 2B and 2D and yellow ink is supplied to the ink supply port 2C. A discharge port plate 9 to be jointed to the substrate 1 is provided with large liquid droplet discharge ports 3a for discharging large liquid droplets and small liquid droplet discharge ports 3b for discharging small liquid droplets with respect to the respective ink supply ports 2. Regarding the ink supply ports 2A and 2B, the large liquid droplet discharge ports 3a are disposed at a left side in FIGS. 1A and 1B and small liquid droplet discharge ports 3b are disposed at a right side in FIGS. 1A and 1B. Regarding the ink supply ports 2D and 2E, the small liquid droplet discharge ports 3b are disposed at a left side in FIGS. 1A and 1B and the large liquid droplet discharge ports 3a are disposed at a right side in FIGS. 1A and 1B, and, regarding the ink supply port 2C, the large ink droplet discharge ports 3a are disposed on both sides. Accordingly, if the substrate 1 is shifted in either direction along an arrangement direction of the ink supply ports 2 (left-and-right direction in FIGS. 1A and 1B), the order for discharging the ink colors onto a recording medium (not shown) becomes the same, thereby preventing generation of color unevenness.

As shown in enlarged views of FIGS. 2A and 2B illustrating left side portions of FIGS. 1A and 1B, the large liquid droplet discharge port 3a is provided at one side of each ink supply port 2 and the small liquid droplet discharge port 3b is provided at the other side. The discharge ports 3a and 3b are communicated with a common liquid chamber 6 via pressure chambers 4a and 4b and ink flow paths 5a and 5b, respectively, and the common liquid chamber 6 is communicated with the ink supply ports 2. Electro-thermal converting elements (referred to as “heaters” hereinafter) 7a and 7b are disposed within the pressure chambers 4a and 4b, respectively. Incidentally, in this specification, a condition that the ink flow path is continued to the pressure chamber is generically referred to as “nozzle.” A cylindrical nozzle filter 8 integrally formed with the discharge port plate 9 is disposed in the vicinity of portions of the common liquid chamber 6 to which the ink flow paths 5a and 5b are connected.

When it is assumed that a length of the nozzle for the large liquid droplet is H_{L}, a length of the nozzle for the small liquid droplet is H_{S}, a width of the nozzle for the large liquid droplet (=width of large liquid droplet ink flow path 5a) is W_{L} and a width of the nozzle for the small liquid droplet (=width of the small liquid droplet ink flow path 5b) is W_{S}, in this reference example, H_{L}<H_{S} and W_{L}=W_{S} are satisfied. Thus, flow resistance of the small liquid droplet ink flow path 5b becomes great. Incidentally, dimensions of H_{L}, H_{S}, W_{L} and W_{S} are within a range in which the flow resistance satisfies the following relationships:

S_{Lb}<S_{Sb}<1.93 S_{Lb}

S_{Lb}=R_{Lf}/(R_{Lf}+R_{LB})×S_{Le}

S_{Sb}=R_{Sf}/(R_{Sf}+R_{Sb})×S_{Se}

S_{Lb}: flow resistance of large liquid droplet side;

S_{Sb}: flow resistance of small liquid droplet side;

R_{Lf}: flow resistance from electro-thermal converting element of large liquid droplet pressure chamber to discharge port;

R_{Lb}: flow resistance from electro-thermal converting element of large liquid droplet ink flow path to common liquid chamber;

S_{Le}: effective bubbling area of the large liquid droplet electro-thermal converting element;

R_{Sf}: flow resistance from electro-thermal converting element of small liquid droplet pressure chamber to discharge port;

R_{Sb}: flow resistance from electro-thermal converting element of small liquid droplet ink flow path to common liquid chamber; and

S_{Se}: effective bubbling area of small liquid droplet electro-thermal converting element.

Further, the flow resistances R_{f} and R_{b} are represented by the following relationships or equations, respectively:

$$Rf = η {\int }_{0}^{H} D ( x ) ⅆ x / {S ( x )}^{2}$$

D(x)=12.0×(0.33+1.02×(a(x)/b(x)+b(x)/a(x)))

R_{f}: flow resistance from electro-thermal converting element to discharge port;

H: distance from electro-thermal converting element to discharge port;

x: distance from electro-thermal converting element;

S(x): sectional area of ink flow path at position of distance x;

D(x): section coefficient of ink flow path at position of distance x;

a(x): height of ink flow path at position of distance x;

b(x): width of ink flow path at position of distance x; and

η: ink viscosity, and,

$$Rb = η {\int }_{0}^{L} D ( y ) ⅆ y / {S ( y )}^{2}$$

D(y)=12.0×(0.33+1.02×(c(y)/d(y)+d(y)/c(y)))

R_{b}: flow resistance from electro-thermal converting element to common liquid chamber;

L: distance from center of electro-thermal converting element to common liquid chamber;

y: distance from the common liquid chamber;

S(y): sectional area of ink flow path at position of distance y;

D(y): section coefficient of ink flow path at position of distance y;

c(y): height of ink flow path at position of distance y; and

d(y): width of ink flow path at position of distance y.

Further, when the flow resistances R_{f} and R_{b} are obtained from dispersion calculations, the following relationships can be obtained:

$$Rf = η {\sum }_{n = 1}^{k} D ( {x}_{n} ) ( {x}_{n} - {x}_{n - 1} ) / {S ( {x}_{n} )}^{2}$$

D(xₙ)=12.0×(0.33+1.02×(a(xₙ)/b(xₙ)+b(xₙ)/a(xₙ)))

R_{f}: flow resistance from electro-thermal converting element to discharge port;

k: division number of distance from electro-thermal converting element to discharge port;

xₙ: distance from electro-thermal converting element to n-th division position when distance from electro-thermal converting element to discharge port is divided into k sections;

S(xₙ): sectional area of ink flow path at position of xₙ;

D(xₙ): section coefficient of ink flow path at position of xₙ;

a(xₙ): height of ink flow path at position of xₙ;

b(xₙ): width of ink flow path at position of xₙ; and

η: ink viscosity, and,

$$Rb = η {\sum }_{n = 1}^{l} D ( {y}_{n} ) ( {y}_{n} - {y}_{n - 1} ) / {S ( {y}_{n} )}^{2}$$

D(yₙ)=12.0×(0.33+1.02×(c(yₙ)/d(yₙ)+d(yₙ)/c(yₙ)))

R_{b}: flow resistance from electro-thermal converting element to common liquid chamber;

l: division number of distance from center of electro-thermal converting element to common liquid chamber;

yₙ: distance from common liquid chamber to n-th division position when distance from center of electro-thermal converting element to common liquid chamber is divided into l sections;

S(yₙ): sectional area of ink flow path at position of yₙ;

D(yₙ): section coefficient of ink flow path at position of yₙ;

c(yₙ): height of ink flow path at position of yₙ; and

d(xₙ): width of ink flow path at position of yₙ.

Further, when the flow resistances are defined by inertance, the following relationships are obtained:

$$Rf = ρ {\int }_{0}^{H} ⅆ x / S ( x )$$

R_{f}: flow resistance from electro-thermal converting element to discharge port;

H: distance from electro-thermal converting element to discharge port;

x: distance from electro-thermal converting element;

S(x): sectional area of ink flow path at position of distance x; and

ρ: ink density, and,

$$Rb = ρ {\int }_{0}^{L} dy / S ( y )$$

R_{b}: flow resistance from electro-thermal converting element to common liquid chamber;

L: distance from center of electro-thermal converting element to common liquid chamber;

y: distance from the common liquid chamber; and

S(y): sectional area of ink flow path at position of distance y.

Alternatively, the flow resistances can be represented by the following equations:

$$Rf = ρ {\sum }_{n = 1}^{k} ( {x}_{n} - {x}_{n - 1} ) / S ( {x}_{n} )$$

R_{f}: flow resistance from electro-thermal converting element to discharge port;

k: division number of distance from electro-thermal converting element to discharge port;

xₙ: distance from electro-thermal converting element to n-th division position when distance from electro-thermal converting element to discharge port is divided into k sections;

S(xₙ): sectional area of ink flow path at position of xₙ; and

η: ink viscosity, and,

$$Rb = ρ {\sum }_{n = 1}^{l} ( {y}_{n} - {y}_{n - 1} ) / S ( {y}_{n} )$$

R_{b}: flow resistance from electro-thermal converting element to common liquid chamber;

l: division number of distance from center of electro-thermal converting element to common liquid chamber;

yₙ: distance from common liquid chamber to n-th division position when distance from center of electro-thermal converting element to common liquid chamber is divided into l sections; and

S(yₙ): sectional area of ink flow path at position of yₙ.

Tests regarding the discharging of the large liquid droplet (discharging amount of 5 pl) and the discharging of the small liquid droplet (discharging amount of 2 pl) were actually performed by using the ink jet recording head according to this reference example, and a relationship between image quality experimentally obtained (particularly, occurrence of a phenomenon in which the discharging is distorted at random to form poor dots) and the flow resistances S_{Sb} and S_{Lb} obtained by the calculations was verified. Results are shown in the following Table 1. In this reference example, the ink discharging was performed by a nozzle No. 1 for discharging the large liquid droplet of 5 pl with nozzles in which various conditions are changed. As shown in the Table 1, an example in which two nozzles No. 1 for discharging the large liquid droplet of 5 pl are combined and examples in which the nozzle No. 1 is combined with nozzles Nos. 2 to 5 for discharging the small liquid droplet of 2 pl is combined, respectively was compared.

Incidentally, effective areas of the heaters 7a and 7b are sought as follows. Since peripheral zones of 2 μm from edges of the heaters 7a and 7b are hard to be temperature-increased and thus do not contribute to the bubbling, the effective area is calculated as an area smaller than the actual size by 2 μm inside. For example, the effective area of each heater 7a or 7b having a size of 22×22 μm is (22−2×2)×(22−2×2)=18×18=324 μm². Further, a height of each ink flow path 5a or 5b of this ink jet recording head is 14 μm, and widths of the flow paths 5a and 5b are W_{L}=W_{S}=32 μm. Incidentally, R_{f} is resistance of the discharge port 3a or 3b alone.

TABLE 1
Relationship between flow resistances S_{Lb}, S_{sb}
and image quality

| NozzleNo. | 1 | 2 | 3 | 4 | 5 |
|---|---|---|---|---|---|
| Discharged Amount | 5 | 2 | 2 | 2 | 2 |
| (pl) | | | | | |
| Discharge Port | 16 | 10.5 | 10.5 | 10.5 | 10.5 |
| Diameter (μm) | | | | | |
| Nozzle Filter | 10 | 10 | 10 | 10 | 15 |
| Diameter (μm) | | | | | |
| Heater Size (μm) | 26 × 26 | 26 × 26 | 24 × 24 | 22 × 22 | 26 × 26 |
| Flow Resistance | 199 | 384 | 317 | 257 | 262 |
| S_{Lb}, S_{sb} (μm²) | | | | | |
| S_{sb}/S_{Lb} Ratio | 1 | 1.93 | 1.59 | 1.29 | 1.32 |
| Image Quality | ◯ | X | Δto ◯ | ◯ | ◯ |

As shown in the above Table 1, in the example in which two nozzles No. 1 for the large liquid droplet are combined, poor printing such as poor dot formation is not generated at all and image quality is good.

In the example in which the nozzle No. 2 having a discharge port diameter smaller than that of the nozzle No. 1 and adapted to discharge the small liquid droplet of 2 pl is combined with the nozzle No. 1, considerable poor dot formation was generated at the nozzle No. 2 and the image quality was very bad. Incidentally, the flow resistance S_{Sb} of the nozzle No. 2 is greater than the flow resistance S_{Lb} of the nozzle No. 1 by 1.93 times.

In the examples in which the nozzle No. 3 having a heater size of 24×24 μm smaller than that of the nozzle No. 2 and the nozzle No. 4 having a smaller heater size of 22×22 μm are used, respectively, the poor dot formation was suppressed and the image quality was enhanced. In the nozzle No. 3, in a certain case, although slight poor dot formation was generated, in the nozzle No. 4, the poor dot formation was not generated at all and the image quality was very good. Incidentally, S_{Sb}/S_{Lb} ratios of the nozzles No. 3 and No. 4 are 1.59 and 1.29, respectively.

Further, in the example in which the nozzle No. 5 having a greater diameter of the nozzle filter 8 than that of the nozzle No. 2 to increase the flow resistance S_{Sb} was used, the poor dot formation was not generated so much and the image quality was good. An S_{Sb}/S_{Lb} ratio thereof is 1.32.

From the above-mentioned results, it can be seen that, in order to maintain a good discharging condition of the small liquid droplet, it is important that escaping of the bubbling power toward the direction of the common liquid chamber 6 is suppressed and cross-talk via the common liquid chamber 6 is suppressed. Quantitatively, in order to suppress the calculated escaping amount of the bubbling power toward the direction of the common liquid chamber 6 to a predetermined amount or less, it is important that various sizes are set on the basis of the above-mentioned relationships or equations. The S_{Sb}/S_{Lb} ratio corresponding to the escaping amount of the bubbling power from the small liquid droplet ink flow path 5b to the common liquid chamber 6 must be below at least 1.93 and is more preferably smaller than 1.59. Further, according to the above-mentioned flow resistance calculations, an absolute value of the flow resistance S_{Sb} must also be below 384 μm² and is more preferably smaller than 317 μm².

As mentioned above, by determining sizes of various parts and flow resistances on the basis of the above-mentioned calculations, the cross-talk caused by the escaping of the bubbling power toward the common liquid chamber 6 at the small liquid droplet ink flow path 5b is reduced, with the result that the liquid droplet discharging is stabilized to prevent the poor recording such as the poor dot formation, thereby permitting high quality image formation.

### Second Reference Example

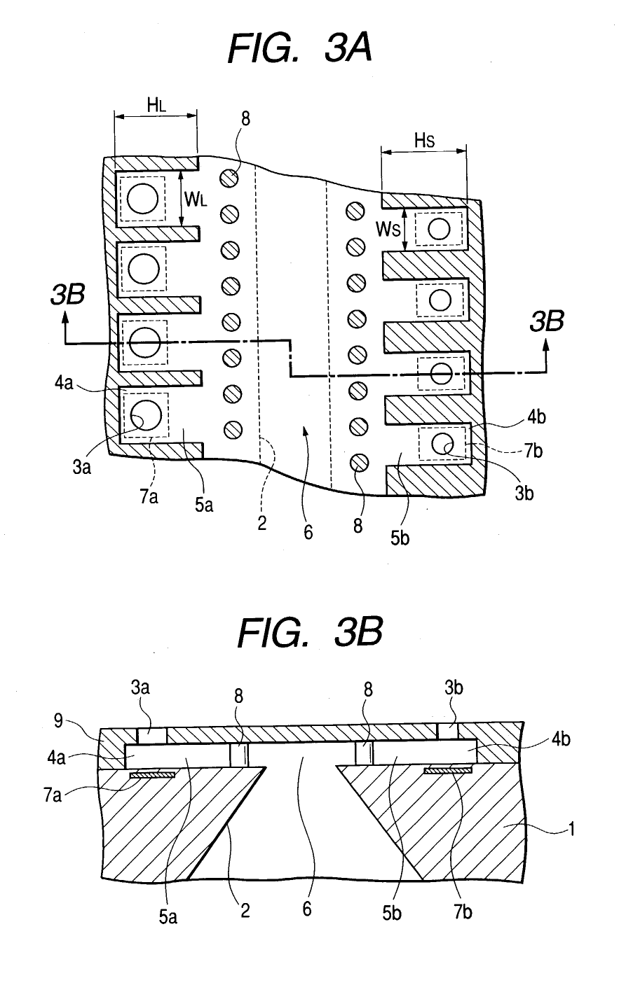

Next, an ink jet recording head according to a second reference example will be explained with reference to FIGS. 3A and 3B. Explanation of the same parts as those in the first reference example will be omitted.

In this reference example, H_{L}=H_{S} and W_{L}>W_{S} are satisfied. Sizes of various parts including W_{S} are sought by calculations similar to those in the first reference example.

In the first reference example, although there is a problem that the small liquid droplet ink flow paths 5b are lengthened and thus the dimension of the entire ink jet recording head is increased, in the second reference example, the flow resistances S_{Sb} of the small liquid droplet ink flow paths 5b can be increased without increasing the dimension of the ink jet recording head.

(First Embodiment)

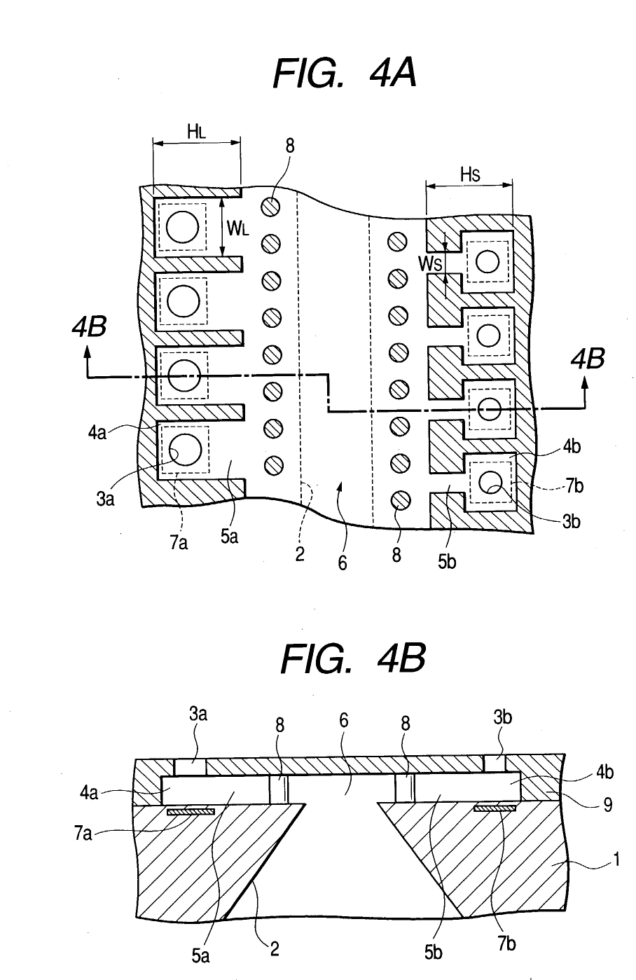

Next, a first embodiment of an ink jet recording head of the present invention will be explained with reference to FIGS. 4A and 4B. Explanation of the same parts as those in the first and second reference examples will be omitted.

In the first embodiment, H_{L}=H_{S} and W_{L}>W_{S} are satisfied, and, thus, the width of the small liquid droplet ink flow path 5b is smaller than the width of the small liquid droplet pressure chamber 4b. That is to say, although the large liquid droplet ink flow path 5a is directly connected to the large liquid droplet pressure chamber 4a with the same width, the small liquid droplet ink flow path 5b has the width smaller than that of the small liquid droplet pressure chamber 4b, and, thus, restriction for the ink flow is formed between the ink flow path and the pressure chamber. Incidentally, sizes of various parts are determined by calculations similar to those in the first reference example.

In the construction of the second reference example, the entire width of the small liquid droplet ink flow path 5b is small to make the configuration of the heater 4b narrower thereby to limit the size designing of the heater 4b, with the result that the driving designing and the designing of the resistance of the heater film are apt to be limited. Further, positional deviation of the nozzle in a short side direction of the heater 4b easily affects an influence upon the discharging direction. Further, there is a problem that, if the effective bubbling area is changed due to long term use, the change rate of the effective bubbling area becomes great. To the contrary, in the first embodiment, a degree of freedom of the designing of the size of the heater 4b is great and a degree of freedom of the driving designing and the designing of the heater film is great. Further, since the configuration of the heater can be selected as a square, the influence of the positional deviation of the nozzle affecting upon the discharge direction can be minimized, with the result that the change rate of the effective bubbling area during the long term use can be minimized. The other constructions are the similar to those in the first reference example.

(Second Embodiment)

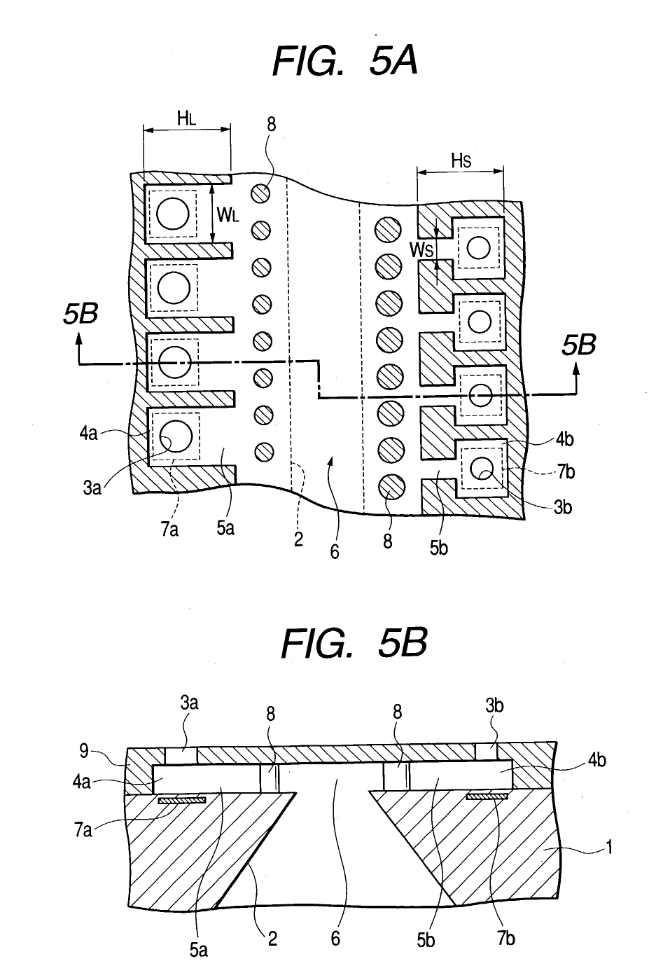

Next, a second embodiment of an ink jet recording head of the present invention will be explained with reference to FIGS. 5A and 5B. Explanation of the same parts as those in the first and second reference examples and the first embodiment will be omitted.

In the second embodiment, a diameter of a nozzle filter 8b corresponding to the small liquid droplet ink flow path 5b is great. The other constructions are the same as those in the first embodiment. Sizes of various parts including the dimension of the nozzle filter 8b are sought by calculations similar to those in the first reference example.

In the second embodiment, even when the width W_{S} of the small liquid droplet ink flow path 5b is not narrowed extremely, the flow resistance S_{Sb} can be increased and optimized by making the nozzle filter 8b larger. Accordingly, there is little influence of manufacturing tolerance of the ink flow path 5b and dispersion in the flow resistances S_{Sb} of the nozzles for the small liquid droplet is hard to be not so great. Further, since the width W_{S} of the small liquid droplet ink flow path 5b is not so narrow and the nozzle filter 8b is large, dirt or debris is hard to be clogged.

### Third Reference Example

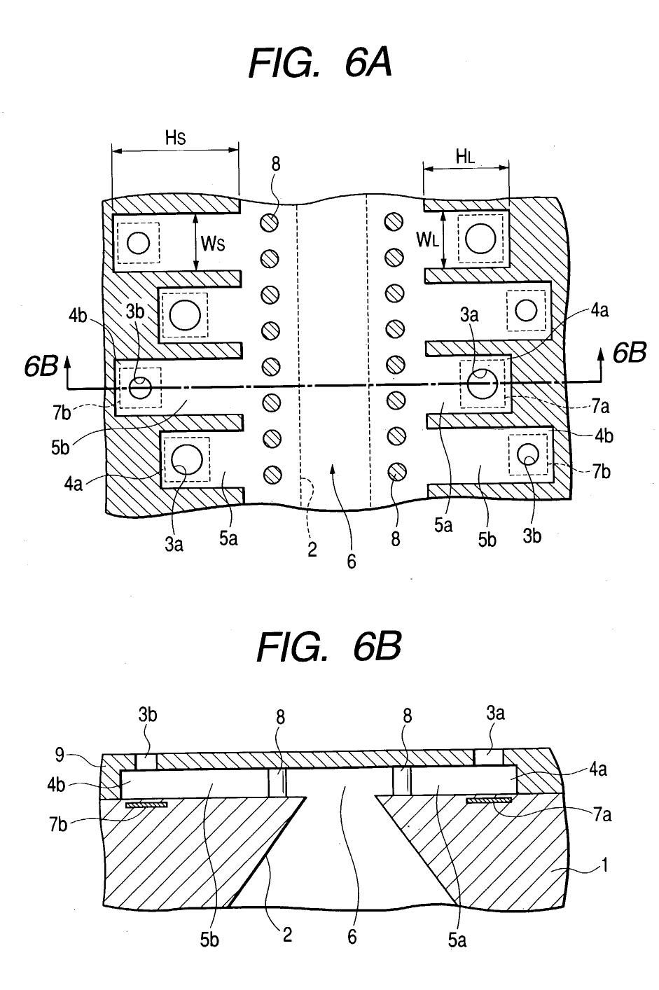

Next, an ink jet recording head according to a third reference example will be explained with reference to FIGS. 6A and 6B. Explanation of the same parts as those in the first and second reference examples will be omitted.

In this reference example, the small liquid droplet nozzles and the large liquid droplet nozzles are alternately disposed in the same column. The other constructions are the same as those in the first reference example.

In this reference example, since the distance between the large liquid droplet ink flow paths 5a and the distance between the small liquid droplet ink flow paths 5b can be widened, the cross-talk and influence of air flow between the large liquid droplet ink flow paths 5a or between the small liquid droplet ink flow paths 5b caused when high speed printing is performed by using only the large liquid droplets or the small liquid droplets can be reduced, thereby stabilizing the discharging and permitting high speed printing of a high quality image.

### Fourth Reference Example

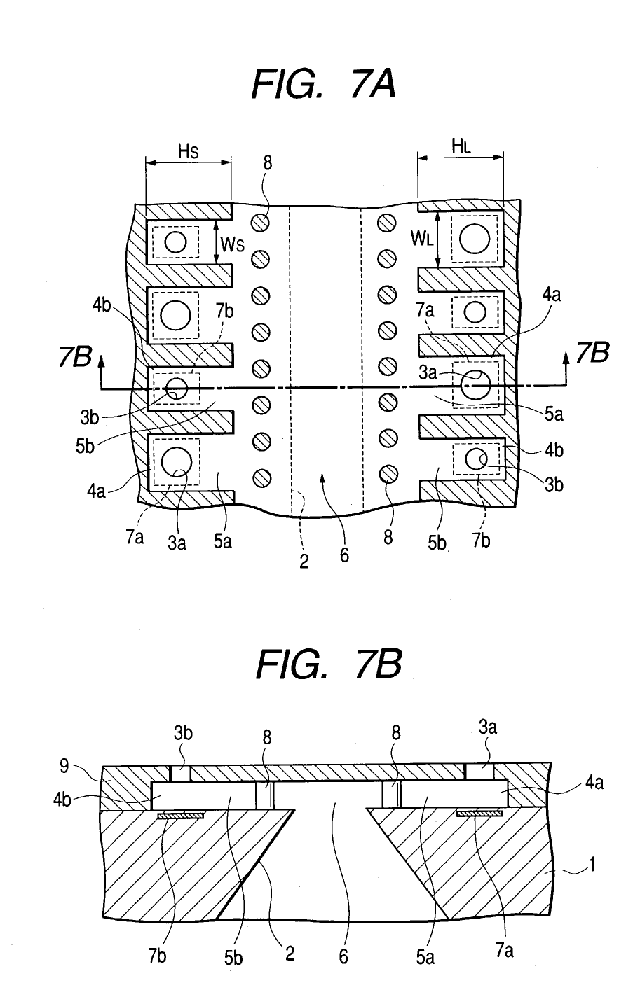

Next, an ink jet recording head according to a fourth reference example will be explained with reference to FIGS. 7A and 7B. Explanation of the same parts as those in the first to third reference examples will be omitted.

In this reference example, the small liquid droplet nozzles and the large liquid droplet nozzles are alternately disposed in the same column. The other constructions are the same as those in the second reference example. Accordingly, similar to the third reference example, the cross-talk and the influence of the air flow caused when the high speed printing is performed by using only the large liquid droplets or small liquid droplets can be reduced, thereby stabilizing the discharging and permitting high speed printing of a high quality image. Further, similar to the second reference example, the flow resistances S_{Sb} of the small liquid droplet ink flow paths 5b can be increased without increasing the size of the ink jet recording head.

(Third Embodiment)

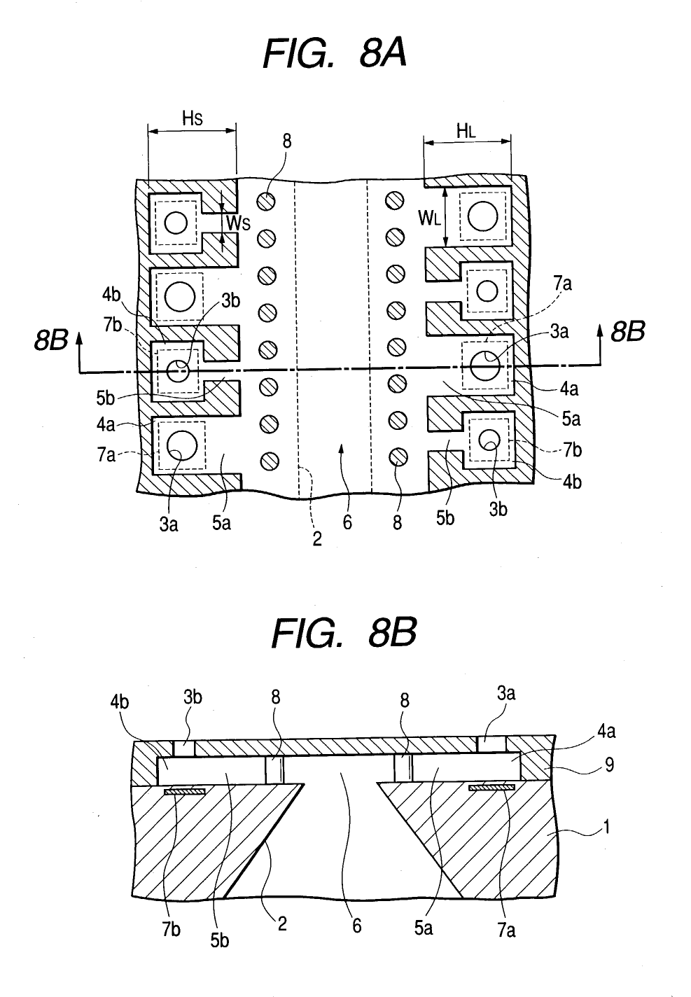

Next, a third embodiment of an ink jet recording head of the present invention will be explained with reference to FIGS. 8A and 8B. Explanation of the same parts as those in the first to fourth reference examples and the first and second embodiments will be omitted.

In the third embodiment, the small liquid droplet nozzles and the large liquid droplet nozzles are alternately disposed in the same column. The other constructions are the same as those in the first embodiment. Accordingly, similar to the first embodiment, the degree of freedom of designing of the size of the heater 4b is great, with the result that the influence of the positional deviation of the nozzle affecting upon the discharging direction can be minimized and the change rate of the effective bubbling area during the long term use can be minimized. Further, similar to the fourth reference example, the cross-talk and the influence of the air flow caused when the high speed printing is performed by using only the large liquid droplets or small liquid droplets can be reduced, thereby stabilizing the discharging and permitting high speed printing of a high quality image, and further, the flow resistances S_{Sb} of the small liquid droplet ink flow paths 5b can be increased without increasing the size of the ink jet recording head.

(Fourth Embodiment)

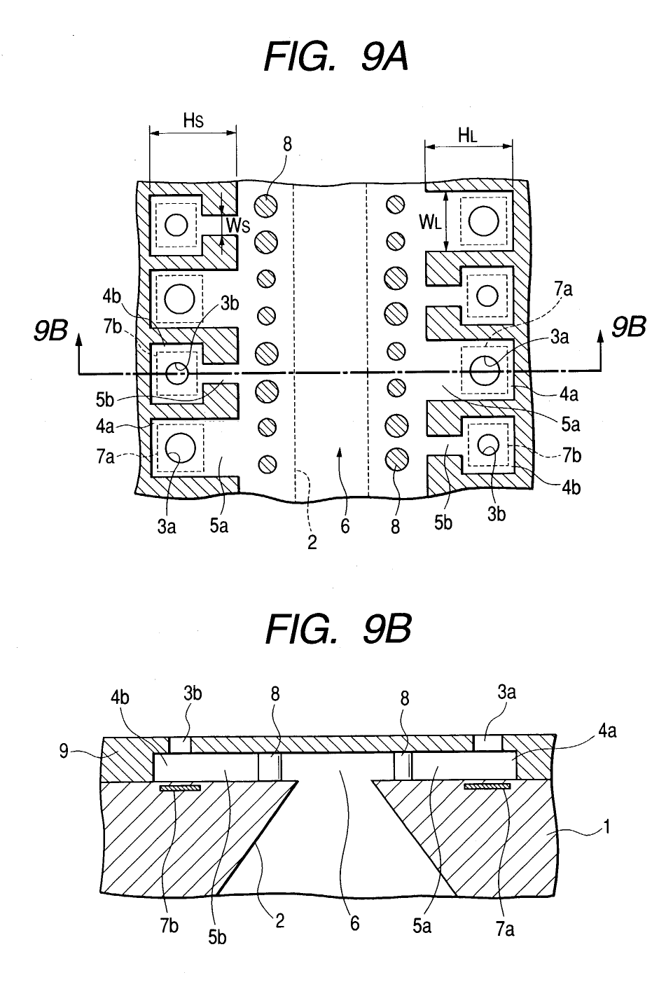

Next, a fourth embodiment of an ink jet recording head of the present invention will be explained with reference to FIGS. 9A and 9B. Explanation of the same parts as those in the first to fourth reference examples and the first to third embodiments will be omitted.

In the fourth embodiment, the small liquid droplet nozzles and the large liquid droplet nozzles are alternately disposed in the same column and the diameter of the nozzle filter 8b corresponding to the small liquid droplet ink flow path 65b is great. The other constructions are the same as those in the third embodiment. Accordingly, similar to the first embodiment, the degree of freedom of designing of the size of the heater 4b is great, with the result that the influence of the positional deviation of the nozzle affecting upon the discharging direction can be minimized and the change rate of the effective bubbling area during the long term use can be minimized. Further, similar to the fourth reference example, the cross-talk and the influence of the air flow caused when the high speed printing is performed by using only the large liquid droplets or small liquid droplets can be reduced, thereby stabilizing the discharging and permitting high speed printing of a high quality image, and further, the flow resistances S_{Sb} of the small liquid droplet ink flow paths 5b can be increased without increasing the size of the ink jet recording head. Further, similar to the second embodiment, dispersion in the flow resistances S_{Sb} of the nozzles for the small liquid droplet is hard to be great so much and thus the dirt is hard to be clogged.

(Fifth Embodiment)

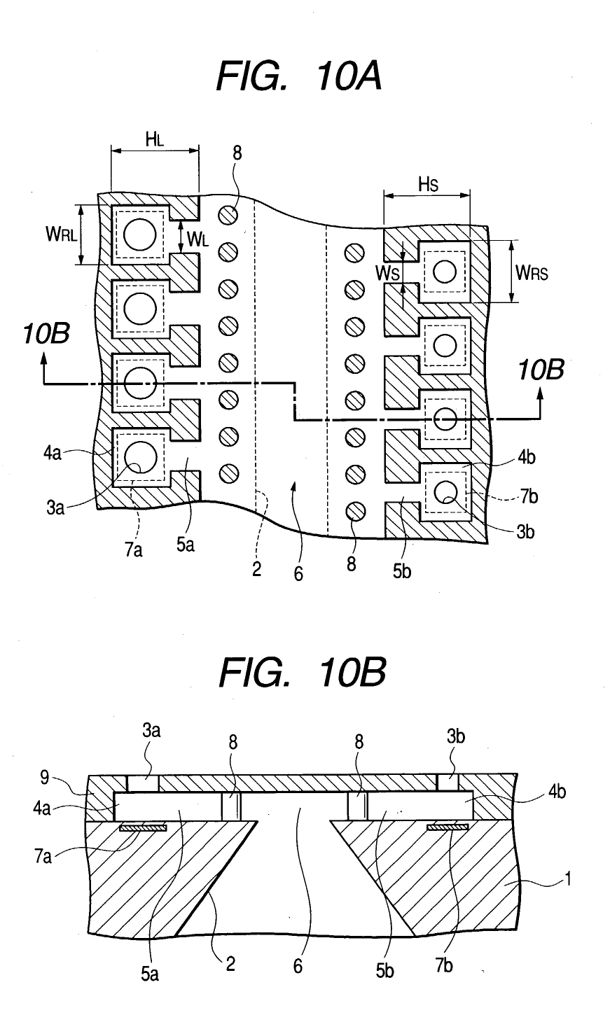

Next, a fifth embodiment of an ink jet recording head of the present invention will be explained with reference to FIGS. 10A and 10B. Explanation of the same parts as those in the first to fourth reference examples and the first to fourth embodiments will be omitted.

In the fifth embodiment, the width of the small liquid droplet ink flow path 5b is narrower than the width of the small liquid droplet pressure chamber 4b and the width of the large liquid droplet ink flow path 5a is narrower than the width of the large liquid droplet pressure chamber 4a so that both of the small liquid droplet ink flow path 5b and the large liquid droplet ink flow path 5a act as restriction portions for the ink flow. That is to say, when it is assumed that the width of the large liquid droplet pressure chamber is W_{RL}, the width of the large liquid droplet ink flow path is W_{L}, the width of the small liquid droplet pressure chamber is W_{RS} and the width of the small liquid droplet ink flow path is W_{S}, W_{RL}≅W_{RS} and W_{L}>W_{S} and W_{S}/W_{RS}<W_{L}/W_{RL} are satisfied. The other constructions are the same as those in the first embodiment. Accordingly, in not only the small liquid droplet ink flow paths 5b but also the large liquid droplet ink flow paths 5a, the flow resistances can be increased without increasing the size of the ink jet recording head. Further, the degree of freedom of designing of the sizes of the heaters 4a and 4b is great, with the result that the influence of the positional deviation of the nozzle affecting upon the discharging direction can be minimized and the change rate of the effective bubbling area during the long term use can be minimized.

### Example

The Inventors manufactured many nozzles and judged recording properties thereof. Among them, regarding the nozzles, which were able to achieve the good recording, heater sizes, pressure chamber volumes and pressure chamber widths are shown by Nos. 4 to 27. Further, Nos. 1 to 3 shows reference designing example when the heater size could be reduced.

TABLE 2

| | | | | | | Embodiment 1 | | Embodiment 2 | | Embodiment 3 | |
|---|---|---|---|---|---|---|---|---|---|---|---|
| | | | | | | Heater (12.5 × 28) × 2 | | Heater 26 × 26 | | Heater 30 × 30 | |
| | | | | | | Discharged Amount | | Discharged Amount | | Discharged Amount | |
| Sample Nozzle 5.4 (pl) | | | | | | 5.4 (pl) | | 8.5 (pl) | | | |
| | Dis- | | | Pressure | | | | | | | |
| | charged | Heater | | Chamber | | Pressure Chamber | | Pressure Chamber | | Pressure Chamber | |
| | Amount | | Total | Bottom | | Bottom | Width | Bottom | Width | Bottom | Width |
| No. | (pl) | Size | Area | Area | Width | Area Ratio | Ratio | Area Ratio | Ratio | Area Ratio | Ratio |
| 1 | 0.5 | 12 × 12 | 144 | 256 | 16 | 0.25 | 0.50 | 0.28 | 0.53 | 0.22 | 0.47 |
| 2 | 0.5 | 13 × 13 | 169 | 289 | 17 | 0.28 | 0.53 | 0.32 | 0.57 | 0.25 | 0.50 |
| 3 | 0.5 | 14 × 14 | 196 | 324 | 18 | 0.32 | 0.56 | 0.36 | 0.60 | 0.28 | 0.53 |
| 4 | 0.5 | 16 × 16 | 256 | 400 | 20 | 0.39 | 0.63 | 0.44 | 0.67 | 0.35 | 0.59 |
| 5 | 0.5 | 17 × 17 | 289 | 441 | 21 | 0.43 | 0.66 | 0.49 | 0.70 | 0.38 | 0.62 |
| 6 | 0.5 | 18 × 18 | 324 | 484 | 22 | 0.47 | 0.69 | 0.54 | 0.73 | 0.42 | 0.65 |
| 7 | 0.5 | 19 × 19 | 361 | 529 | 23 | 0.52 | 0.72 | 0.59 | 0.77 | 0.46 | 0.68 |
| 8 | 1.0 | 20 × 20 | 400 | 576 | 24 | 0.56 | 0.75 | 0.64 | 0.80 | 0.50 | 0.71 |
| 9 | 1.0 | 21 × 21 | 441 | 625 | 25 | 0.61 | 0.78 | 0.69 | 0.83 | 0.54 | 0.74 |
| 10 | 2.4 | 22 × 22 | 484 | 676 | 26 | 0.66 | 0.81 | 0.75 | 0.87 | 0.58 | 0.76 |
| 11 | 2.4 | 23 × 23 | 529 | 729 | 27 | 0.71 | 0.84 | 0.81 | 0.90 | 0.63 | 0.79 |
| 12 | 2.4 | 20 × 24 | 480 | 672 | 24 | 0.66 | 0.75 | 0.75 | 0.80 | 0.58 | 0.71 |
| 13 | 2.4 | (11.5 × 27) × 2 | 621 | 930 | 30 | 0.91 | 0.94 | 1.03 | 1.00 | 0.80 | 0.88 |
| 14 | 4.5 | 24 × 24 | 576 | 784 | 28 | 0.77 | 0.88 | 0.87 | 0.93 | 0.68 | 0.82 |
| 15 | 4.5 | 25 × 25 | 625 | 841 | 29 | 0.82 | 0.91 | 0.93 | 0.97 | 0.73 | 0.85 |
| 16 | 5.4 | 26 × 26 | 676 | 900 | 30 | 0.88 | 0.94 | 1.00 | 1.00 | 0.78 | 0.88 |
| 17 | 5.4 | 27 × 27 | 729 | 961 | 31 | 0.94 | 0.97 | 1.07 | 1.03 | 0.83 | 0.91 |
| 18 | 5.4 | (12.5 × 28) × 2 | 700 | 1,024 | 32 | 1.00 | 1.00 | 1.14 | 1.07 | 0.89 | 0.94 |
| 19 | 8.5 | 28 × 28 | 784 | 1,024 | 32 | 1.00 | 1.00 | 1.14 | 1.07 | 0.89 | 0.94 |
| 20 | 8.5 | 29 × 29 | 841 | 1,089 | 33 | 1.06 | 1.03 | 1.21 | 1.10 | 0.94 | 0.97 |
| 21 | 8.5 | 30 × 30 | 900 | 1,156 | 34 | 1.13 | 1.06 | 1.28 | 1.13 | 1.00 | 1.00 |
| 22 | 8.5 | 31 × 31 | 961 | 1,225 | 35 | 1.20 | 1.09 | 1.36 | 1.17 | 1.06 | 1.03 |
| 23 | 8.5 | 32 × 32 | 1,024 | 1,296 | 36 | 1.27 | 1.13 | 1.44 | 1.20 | 1.12 | 1.06 |
| 24 | 8.5 | 33 × 33 | 1,089 | 1,369 | 37 | 1.34 | 1.16 | 1.52 | 1.23 | 1.18 | 1.09 |
| 25 | 8.5 | 34 × 34 | 1.156 | 1,444 | 38 | 1.41 | 1.19 | 1.60 | 1.27 | 1.25 | 1.12 |
| 26 | 8.5 | 35 × 35 | 1,225 | 1,521 | 39 | 1.49 | 1.22 | 1.69 | 1.30 | 1.32 | 1.15 |
| 27 | 8.5 | 36 × 36 | 1,296 | 1,600 | 40 | 1.56 | 1.25 | 1.78 | 1.33 | 1.38 | 1.18 |

What is claimed is:

1. An ink jet recording head in which a plurality of pressure chambers are connected,to a plurality of ink flow paths branched from a common liquid chamber, respectively and a plurality of discharge ports are communicated with said plurality of pressure chambers, respectively and a plurality of electro-thermal converting elements are disposed within said plurality of pressure chambers, respectively and inks supplied from said common liquid chamber to said pressure chamber can be discharged from said discharge port by pressure generated in said pressure chamber by heat from said electro-thermal converting element, wherein:
said plurality of pressure chambers include a small liquid droplet pressure chamber for discharging a small liquid droplet and a large liquid droplet pressure chamber for discharging a large liquid droplet; and
regarding said ink flow path for the small liquid droplet connected to said small liquid droplet pressure chamber, said small liquid droplet pressure chamber, said ink flow path for the large liquid droplet connected to said large liquid droplet pressure chamber and said large liquid droplet pressure chamber, when a section substantially perpendicular to ink flows directing from said respective ink flow paths to said respective pressure chambers are looked at, a relationship between a sectional area S_{S} of said small liquid droplet ink flow path, a sectional area S_{RS} of said small liquid droplet pressure chamber, a sectional area S_{L} of said large liquid droplet ink flow path and a sectional area S_{RL} of said large liquid droplet pressure chamber satisfies S_{S}/S_{RS}<S_{L}/S_{RL}.

2. An ink jet recording head according to claim 1, wherein a relationship between the sectional area S_{RS} of said small liquid droplet pressure chamber and the sectional area S_{RL} of said large liquid droplet pressure chamber and an ink amount I_{S} of the small liquid droplet discharged from said small liquid droplet pressure chamber and an ink amount I_{L} of the large liquid droplet discharged from said large liquid droplet pressure chamber satisfies S_{RS}/S_{RL}>I_{S}/I_{L}.

3. An ink jet recording head according to claim 2, wherein 1≧S_{RS}/S_{RL}≧0.5 is satisfied.

4. An ink jet recording head according to claim 3, wherein 1≧S_{RS}/S_{RL}≧0.7 is satisfied.

5. An ink jet recording head according to claim 1, wherein a relationship between a volume V_{RS} of said small liquid droplet pressure chamber and a volume V_{RL} of said large liquid droplet pressure chamber and an ink amount I_{S} of the small liquid droplet discharged from said small liquid droplet pressure chamber and an ink amount I_{L} of the large liquid droplet discharged from said large liquid droplet pressure chamber satisfies V_{RS}/V_{RL}>I_{S}/I_{L}.

6. An ink jet recording head according to claim 5, wherein 1≧V_{RS}/V_{RL}≧0.3 is satisfied.

7. An ink jet recording head according to claim 6, wherein 1≧V_{RS}/V_{RL}≧0.5 is satisfied.

8. An ink jet recording head according to claim 1, wherein the sectional area S_{RS} of said small liquid droplet pressure chamber is substantially the same as the sectional area S_{RL} of said large liquid droplet pressure chamber.

9. An ink jet recording head according to claim 8, wherein 1≧S_{RS}/S_{RL}≧0.9 is satisfied.

10. An ink jet recording head according to claim 1, wherein a volume V_{RS} of said small liquid droplet pressure chamber is substantially the same as a volume V_{RL} of said large liquid droplet pressure chamber.

11. An ink jet recording head according to claim 10, wherein 1≧V_{RS}/V_{RL}≧0.8 is satisfied.

12. An ink jet recording head according to claim 8, wherein S_{L}=S_{RL} and S_{S}<S_{RS} are satisfied.

13. An ink jet recording head according to claim 1, wherein the following relationships are satisfied:
S_{Lb}<S_{Sb}<1.93 S_{Lb}
S_{Lb}=R_{Lf}/(R_{Lf}+R_{Lb})×S_{Le}
S_{Sb}=R_{Sf}/(R_{Sf}+R_{Sb})×S_{Se}
where,
S_{Lb}: flow resistance of large liquid droplet side;
S_{Sb}: flow resistance of small liquid droplet side;
R_{Lf}: flow resistance from electro-thermal converting element of large liquid droplet pressure chamber to discharge port;
R_{Lb}: flow resistance from electro-thermal converting element of large liquid droplet ink flow path to common liquid chamber;
S_{Le}: effective bubbling area of the large liquid droplet electro-thermal converting element;
R_{Sf}: flow resistance from electro-thermal converting element of small liquid droplet pressure chamber to discharge port;
R_{Sb}: flow resistance from electro-thermal converting element of small liquid droplet ink flow path to common liquid chamber; and
S_{Se}: effective bubbling area of small liquid droplet electro-thermal converting element.

14. An ink jet recording head according to claim 13, wherein S_{Lb}≦S_{Sb}≦1.59 S_{Lb} is satisfied.

15. An ink jet recording head according to claim 13, wherein the following relationships are satisfied:
$$Rf = η {\int }_{0}^{H} D ( x ) d x / {S ( x )}^{2}$$
D(x)=12.0×(0.33+1.02×(a(x)/b(x)+b(x)/a(x)))
where,
R_{f}: flow resistance from electro-thermal converting element to discharge port;
H: distance from electro-thermal converting element to discharge port;
x: distance from electro-thermal converting element;
S(x): sectional area of ink flow path at position of distance x;
D(x): section coefficient of ink flow path at position of distance x;
a(x): height of ink flow path at position of distance x;
b(x): width of ink flow path at position of distance x; and
η: ink viscosity, and,
$$Rb = η {\int }_{0}^{L} D ( y ) d y / {S ( y )}^{2}$$
D(y)=12.0×(0.33+1.02×(c(y)/d(y)+d(y)/c(y)))
where,
R_{b}: flow resistance from electro-thermal converting element to common liquid chamber;
L: distance from center of electro-thermal converting element to common liquid chamber;
y: distance from the common liquid chamber;
S(y): sectional area of ink flow path at position of distance y;
D(y): section coefficient of ink flow path at position of distance y;
c(y): height of ink flow path at position of distance y; and
d(y): width of ink flow path at position of distance y.

16. An ink jet recording head according to claim 13, wherein the following relationships are satisfied:
$$Rf = η {\sum }_{n = 1}^{k} D ( {x}_{n} ) ( {x}_{n} - {x}_{n - 1} ) / {S ( {x}_{n} )}^{2}$$
D(xₙ)=12.0×(0.33+1.02×(a(xₙ)/b(xₙ)+b(xₙ)/a(xₙ)
where,
R_{f}: flow resistance from electro-thermal converting element to discharge port;
k: division number of distance from electro-thermal converting element to discharge port;
xₙ: distance from electro-thermal converting element to n-th division position when distance from electro-thermal converting element to discharge port is divided into k sections;
S(xₙ): sectional area of ink flow path at position of
D(xₙ): section coefficient of ink flow path at position of xₙ;
a(xₙ) : height of ink flow path at position of xₙ;
b(xₙ): width of ink flow path at position of xₙ; and
η: ink viscosity, and,
$$Rb = η {\sum }_{n = 1}^{l} D ( {y}_{n} ) ( {y}_{n} - {y}_{n - 1} ) / {S ( {y}_{n} )}^{2}$$
D(yₙ)=12.0×(0.33+1.02×(c(yₙ)/d(yₙ)+d(yₙ)/c(yₙ)))
where,
R_{b}: flow resistance from electro-thermal converting element to common liquid chamber;
l: division number of distance from center of electro-thermal converting element to common liquid chamber;
yₙ: distance from common liquid chamber to n-th division position when distance from center of electro-thermal converting element to common liquid chamber is divided into l sections;
S(yₙ): sectional area of ink flow path at position of yₙ;
D(yₙ): section coefficient of ink flow path at position of yₙ;
c(yₙ): height of ink flow path at position of yₙ; and
d(yₙ): width of ink flow path at position of yₙ.

17. An ink jet recording head according to claim 13, wherein the following relationships are satisfied:
$$Rf = ρ {\int }_{0}^{H} ⅆ x / S ( x )$$
where,
R_{f}: flow resistance from electro-thermal converting element to discharge port;
H: distance from electro-thermal converting element to discharge port;
x: distance from electro-thermal converting element;
S(x): sectional area of ink flow path at position of distance x; and
ρ: ink density, and,
$$Rb = ρ {\int }_{0}^{L} ⅆ Y / S ( y )$$
where,
R_{b}: flow resistance from electro-thermal converting element to common liquid chamber;
L: distance from center of electro-thermal converting element to common liquid chamber;
y: distance from the common liquid chamber; and
S(y): sectional area of ink flow path at position of distance y.

18. An ink jet recording head according to claim 13, wherein the following relationships are satisfied:
$$Rf = ρ {\sum }_{n = 1}^{k} ( {x}_{n} - {x}_{n - 1} ) / S ( {x}_{n} )$$
where,
R_{f}: flow resistance from electro-thermal converting element to discharge port;
k: division number of distance from electro-thermal converting element to discharge port;
xₙ: distance from electro-thermal converting element to n-th division position when distance from electro-thermal converting element to discharge port is divided into k sections;
S(xₙ): sectional area of ink flow path at position of xₙ; and
η: ink viscosity, and,
$$Rb = ρ {\sum }_{n = 1}^{l} ( {y}_{n} - {y}_{n - 1} ) / S ( {y}_{n} )$$
where,
R_{b}: flow resistance from electro-thermal converting element to common liquid chamber;
l: division number of distance from center of electro-thermal converting element to common liquid chamber;
yₙ: distance from common liquid chamber to n-th division position when distance from center of electro-thermal converting element to common liquid chamber is divided into l sections; and
S(yₙ) : sectional area of ink flow path at position of yₙ.

19. An ink jet recording head according to claim 15, wherein the flow resistance R_{f} is a flow resistance of said discharge port.

20. An ink jet recording head according to claim 16, wherein, in said small liquid droplet ink flow path, the following relationship is satisfied:
R_{f}/(R_{f}+R_{b})×Sₑ<384 (μm²)
where,
Sₑ: effective bubbling area of electro-thermal converting element.

21. An ink jet recording head according to claim 20, wherein, in said small liquid droplet ink flow path, the following relationship is satisfied:
199≦R_{f}/(R_{f}+R_{b})×Sₑ≦317 (μm²)

22. An ink jet recording head according to claim 1, wherein an ink amount of the small liquid droplet is below 4 pl.

23. An ink jet recording head according to claim 1, wherein a distance between said discharge port and said electro-thermal converting element are substantially the same as each other regardless of a size of the ink droplet to be discharged.

24. An ink jet recording head according to claim 1, wherein said plurality of discharge ports are formed in the same substrate regardless of a size of the ink droplet to be discharged.

25. An ink jet recording head according to claim 1, wherein, at one side of said common liquid chamber, only said ink flow paths, pressure chambers and discharge ports for discharging an ink droplet having the same size are connected side by side.

26. An ink jet recording head according to claim 1, wherein, at one side of said common liquid chamber, only said ink flow paths, pressure chambers and discharge ports for discharging ink droplets having different sizes are connected alternately side by side.

27. An ink jet recording head according to claim 1, wherein a nozzle filter is disposed between said ink flow path and said common liquid chamber.

28. An ink jet recording head according to claim 27, wherein said nozzle filter provided between said small liquid droplet ink flow path and said common liquid chamber is greater than said nozzle filter provided between said large liquid droplet ink flow path and said common liquid chamber.

29. An ink jet recording head according to claim 1, wherein a driving pulse width Pw of said electro-thermal converting element driven within said pressure chamber is smaller than 1.4 μs.

30. An ink jet recording head according to claim 29, wherein the driving pulse width Pw of said electro-thermal converting element is smaller than 1.2 μs.
